(19) United States
(12) Patent Application Publication
(10) Pub. No.: US 2016/0200509 A1
(43) Pub. Date: Jul. 14, 2016

(54) Trash Can Lock

(71) Applicant: S. Franzen Soehne GmbH, Solingen (DE)

(72) Inventor: Manfred Matuschek, Solingen (DE)

(21) Appl. No.: 14/994,599

(22) Filed: Jan. 13, 2016

(30) Foreign Application Priority Data
Jan. 13, 2015 (DE) 102015100405.4

(51) Int. Cl. B65F 1/14; E05C 19/00; E05C 3/12

(52) U.S. Cl. CPC B65F 1/1615; E05C 3/124; E05C 19/00

(57) ABSTRACT

A trash can lock including an opening slider, displaceable from an initial position into an operating position in the lock housing, a latch with an arm including a locking cam, which, in the initial position, rests against a locking shoulder of the opening slider, and which pivots into a release position in response to a displacement of the opening slider into the operating position, the pivot axis of the latch is arranged to be laterally offset to a straight line, placed through the latch head in a tensile direction (Z), such that the tensile force acts upon the locking cam against the locking shoulder. In the initial position, the locking shoulder is inclined about an angle of inclination (α), which lies within the self-locking range, as compared to the displacement direction of the opening slider.

### FIELD OF THE INVENTION

The invention relates to a trash can lock comprising a latch, which is supported in a lock housing so as to be pivotable about a pivot axis and which has a latch head, to which a counter locking part can apply a tensile force in a tensile direction, and an opening slider, which can be displaced in the lock housing from an initial position into an operating position, wherein the latch has an arm comprising a locking cam, which, in the initial position, rests against a locking shoulder of the opening slider to hold the latch in the locked position, and which pivots into a release position in response to a displacement of the opening slider into the operating position, wherein the pivot axis of the latch is arranged so as to be laterally offset to a straight line, which is placed through the latch head in a tensile direction, in such a manner that the tensile force acts upon the locking cam against the locking shoulder.

### BACKGROUND OF THE INVENTION

The invention furthermore relates to a trash can lock comprising a latch, which is supported in a lock housing so as to be pivotable about a pivot axis and comprising an opening slider, which is arranged in the lock housing and which is displaced from an initial position into an operating position in response to a rotation of the lock about an opening pivot axis (X) in an opening direction of rotation (D), and thereby brings the latch from a locked position into a release position, wherein provision is made for misuse locking elements in the form of a pivot lever, which rests in a pocket, and in the form of a rolling body, which block a displacement of the opening slider into the operating position, when the lock is rotated in a direction of rotation, which is different from the opening direction of rotation, or about an axis of rotation, which is different from the opening axis of rotation.

DE 10 2012 106 531 A1 and DE 10 2007 039 351 A1 in each case describe a trash can lock comprising a housing and a latch, which is supported on the housing in a pivotably movable manner. The latch has a latch head comprising a latch web, which engages below a hook-like protrusion of a counter locking part. The lock can be fastened to the housing of a trash container. The counter locking part is fastened to the bottom side of the lid, which locks a housing opening of the trash container. In the locked position, the latch engages behind the hook, so that the lid cannot be opened. Provision is made for an opening slider, which is displaceably supported in the housing. It embodies a locking shoulder, upstream of which a locking cam is located, which is arranged on an arm of the latch. It is ensured by means of misuse locking elements that the opening slider can only be displaced from an initial position into an operating position, if the trash container is rotated in opening direction. If the trash container is rotated in a different direction of rotation, the misuse locking elements pivot into a locked position and block a displacement of the opening slider. If, in contrast, the trash container is rotated about the opening axis of rotation in the opening direction of rotation, the opening slider is displaced into an operating position as a result of the force of gravity, and controls the latch into a release position, so that the lid can be opened.

### SUMMARY OF THE INVENTION

The invention is based on the object of further developing the generic trash can lock in a manner, which is advantageous for use.

The object is solved by means of the invention, which is specified in the claims. The subclaims do not only represent advantageous further developments of the independent claims, but also independent solutions of the object.

As a result of the lateral offset of the pivot axis to the tensile direction onto the latch head, a force, which acts in tensile direction, exerts a torque onto the latch. Such a force develops in particular in response to overfilling the trash container, when the lid is dosed by comprising the content of the trash container. The torque, which is exerted thereby onto the latch, has the effect that the locking cam exerts a motion-inhibiting friction force on the opening slider. To avoid that this results in a damping effect, which impedes a proper displacement of the latch into the release position, it is proposed that, in the initial position, the locking shoulder is inclined about an angle of inclination, which lies within the self-locking range, as compared to the displacement direction of the opening slider. The angle of inclination can be between three and seven degrees. The opening slider can turn about an angle value, which leads to an increase of the angle of inclination, in response to the opening rotation. The angle of inclination is thereby brought out of the self-locking range. This counteracts a possible jamming of the opening slider. The rotation of the opening slider by this angle value occurs with the help of the force of gravity, when the trash container or the lock, respectively, is rotated in opening direction. The opening slider then pivots about a bearing point by the angle value. Provision is made in particular for the bearing point to be formed by a bearing protrusion of the housing, against which the opening slider can be supported. Preferably, the opening slider is supported on the bearing protrusion by means of a section of a web. The web wall, which is supported on the bearing protrusion, can be the wall of a guide groove. Preferably, the opposite wall of the web is the locking shoulder. The web can thus have a wedge shape. The housing can have a guide rib, which engages with a guide groove of the opening slider. The guide rib engages with the guide groove with a pivot movement play. The guide groove can widen in the displacement direction of the opening slider. The distance of the groove walls increases in the displacement direction of the opening slider. The bearing protrusion can sit on the guide rib. It can be a material thickening of the guide rib.

A further solution of the object is attained by means of a special embodiment of the misuse locking elements. The pivot lever and the rolling body are located in a pocket together, wherein the rolling body is arranged between pivot lever and bottom area of the pocket. The rolling body thus interacts directly with the pivot lever. The pivot lever has a pivot axis. The rolling body can be displaced inside the pocket at right angles to the direction of extension of the pivot axis, so as to thus displace the pivot lever into a misuse locking position. To optimize this effect, the bottom area of the pocket forms two inclined shoulders. As a result of the force of gravity, the rolling body can roll along these inclined shoulders, when the lock housing is rotated in a corresponding direction of rotation. The pivot lever is pushed out of the pocket thereby and reaches a misuse locking position, in which a section of the pivot lever is located in the trajectory of the opening slider, so that the opening slider cannot be displaced into the operating position. The pivot axis of the pivot lever preferably lies parallel to the displacement direction of the opening slider. Accordingly, the rolling body can roll in a direction at right angles to the pivot axis of the pivot lever, thus at right angles to the displacement direction of the opening slider. The pocket has a trapezoidal or trapeze-like cross section and is preferably formed by the lock housing. Preferably, the opening slider has an asymmetrical mass distribution. The center of gravity of the opening slider is located laterally offset to the straight line, which is placed through the latch head in tensile direction. On the side located opposite to the center of gravity, the opening slider has only one arm, which interacts with the misuse locking elements. The pivot lever is located in the trajectory of the arm. The arm has an appendage, which, in the operating position of the opening slider, is located upstream of the pivot lever such that the latter cannot pivot. In the initial position, the arm is located below the pivot lever.

### BRIEF DESCRIPTION OF THE DRAWINGS

An exemplary embodiment of the invention will be explained below by means of enclosed drawings.

FIG. 1 shows a trash can lock comprising an open lock housing 1, wherein an opening slider 10 is in an initial position, so that a locking cam 6 of an arm 4 of a latch 2, which is supported in the housing 1 so as to be pivotable about a pivot axis 5, is supported on a locking shoulder 11 of the opening slider 10,

FIG. 2 shows the section according to line II-II in FIG. 1 through a locking rib 18 of the lock housing 1 and a guide groove 19 of the opening slider 10,

FIG. 3 shows an enlargement of the section III-III in FIG. 1, wherein the locking cam 6′, which is fastened to the arm 4 of the latch 2, is illustrated in a dash-dotted manner, and the locking shoulder 11 of the opening slider 10 as well as the wall 16′ of a web 16 are illustrated in a dashed manner,

FIG. 4 shows an illustration according to FIG. 1 with a partially hidden latch 2 and partially hidden opening slider 10, so that the contact of a wall 20′ of a guide groove 19 to the guide rib 18 and the contact of a wall 16′ and the contact angle α can be seen,

FIG. 5 shows an illustration according to FIG. 4, after the lock housing 1 has been pivoted about an angle of rotation D about the axis X, so that the opening slider 10 has pivoted about the bearing protrusion 17 such that the wall 20 of the guide groove 19 rests against the guide rib 18,

FIG. 6 shows an illustration according to FIG. 1 after a displacement of the opening slider 10 from the initial position into an operating position, wherein the latch 2 has been pivoted into a release position after a control shoulder 28 of the opening slider 10 has acted upon a control cam 7,

FIG. 7 shows the section according to line VII-VII in FIG. 1 through a pocket 24 of the housing 1 and a locking roller 23, which located in the pocket 24, as well as a locking lever 21, which locks the pocket 24, wherein the locking lever 21 is located outside of the trajectory of a locking arm 13 of the opening slider 10,

FIG. 8 shows an illustration according to FIG. 7, but with locking roller 23, which is rolled along an inclined bottom area 25, and with locking lever 21, which is pivoted into the trajectory of the locking arm 13,

FIG. 9 shows a perspective illustration onto the lock interior, approximately in the illustration according to FIG. 6, but with locking lever 21, which is pivoted into a locked position, so that the locking arm 13 is located in a pocket 31 of a journal 21′ of the locking lever 21, and

FIG. 10 shows a section according to line X-X in FIG. 9.

### DETAILED DESCRIPTION OF THE INVENTION

The lock housing 1 consists of plastic and can be fastened to the upper inner edge of a side wall of a trash container. The lid of the trash container has a counter locking part, which is not illustrated in the drawings. With regard to this, reference is made to the corresponding explanations of DE 10 2012 106 531 A1 or DE 10 2007 039 351 A1, respectively. In the closed position of the trash container, a hook protrusion of the counter locking part engages behind a latch web 29 of a latch head 3 of a latch 2. If a force is applied to the trash container lid in upwards direction, which occurs, for example, if an overfilled trash container is closed, a force, which is directed upwards, thus in Z-direction, acts upon the latch head 3.

A neck 9, which protrudes from an opening 30 of the housing 1, is attached to the latch head 2. A straight line G, which runs through the latch web 29 and in tensile direction Z, runs through the neck 9. The pivot axis 5, about which the latch 2 is pivotably supported in the housing 1, is located laterally offset to this straight line G. A control arm 4, which is fixedly connected to the latch head 3 or which is pivotably connected to the latch head 3 only after overcoming a force, extends inside the housing 1 in extension of the neck 9. The latch 2 is acted upon into a locked position by means of an optional return spring 27 in the form of a tension spring, a first end of which engages with a fastening location 8 of the latch 2 and a second end of which engages with the housing 1.

A locking cam 6 is located on the free end of the control arm 4. The locking cam 6 is supported on a locking shoulder 11 of an opening slider 10 in the initial position of the lock, in which the tensile direction Z is oriented upwards.

The opening slider 10 is supported in the lock housing 1 so as to be displaceable in the direction of the straight line G. It has a guide groove 19, which runs in the displacement direction and which engages with a guide rib 18, which is arranged on the bottom of the lock housing 1. In the initial position, a wall 20′ of the guide groove 19 rests against a side wall of the guide rib 18. A wall section 16′ of the guide groove 19 rests against a bearing protrusion 17 of the guide rib 18. As compared to the guide wall 20′, the wall section 16′ is laterally offset about the lateral height of the bearing protrusion 17.

The wall section 16′ is formed by a web 16, the side wall of which, which is located opposite thereto in the wall section 16′, forms the locking shoulder 11, on which the locking cam 6 is supported.

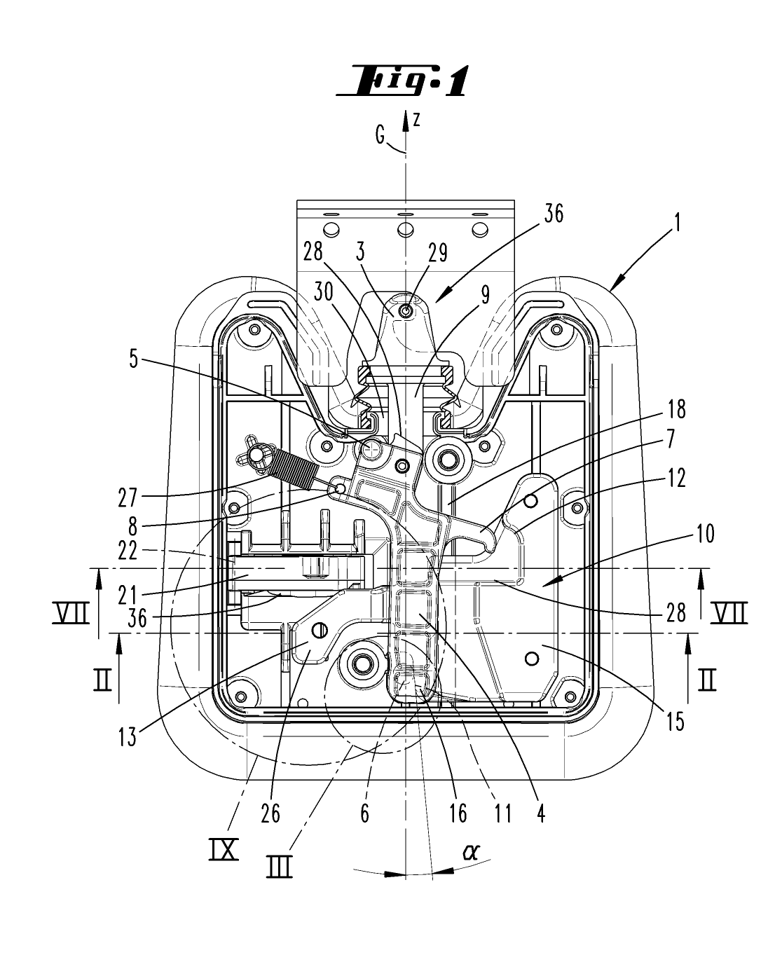

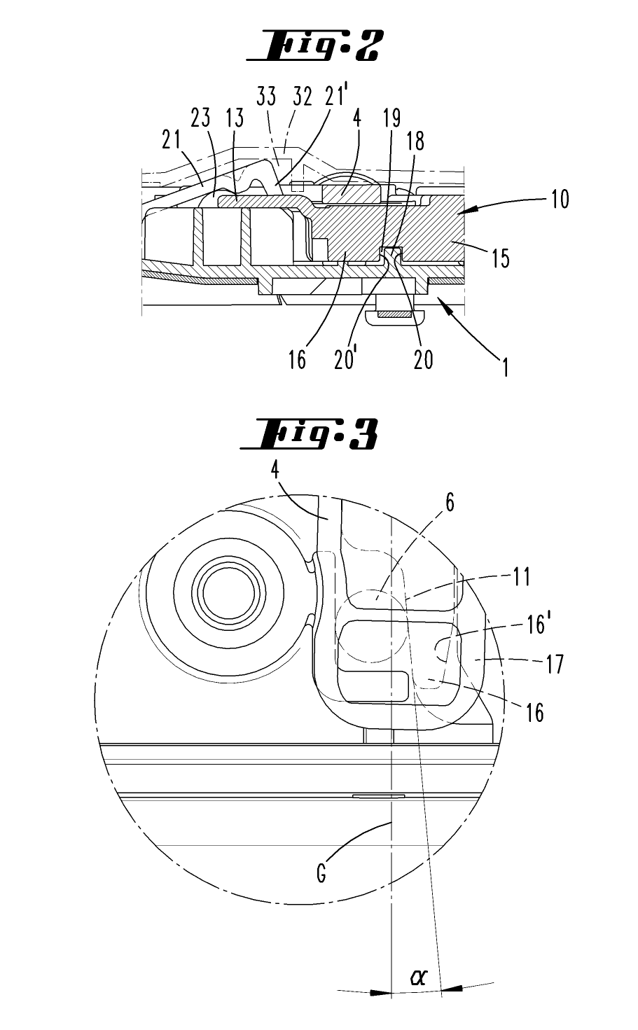

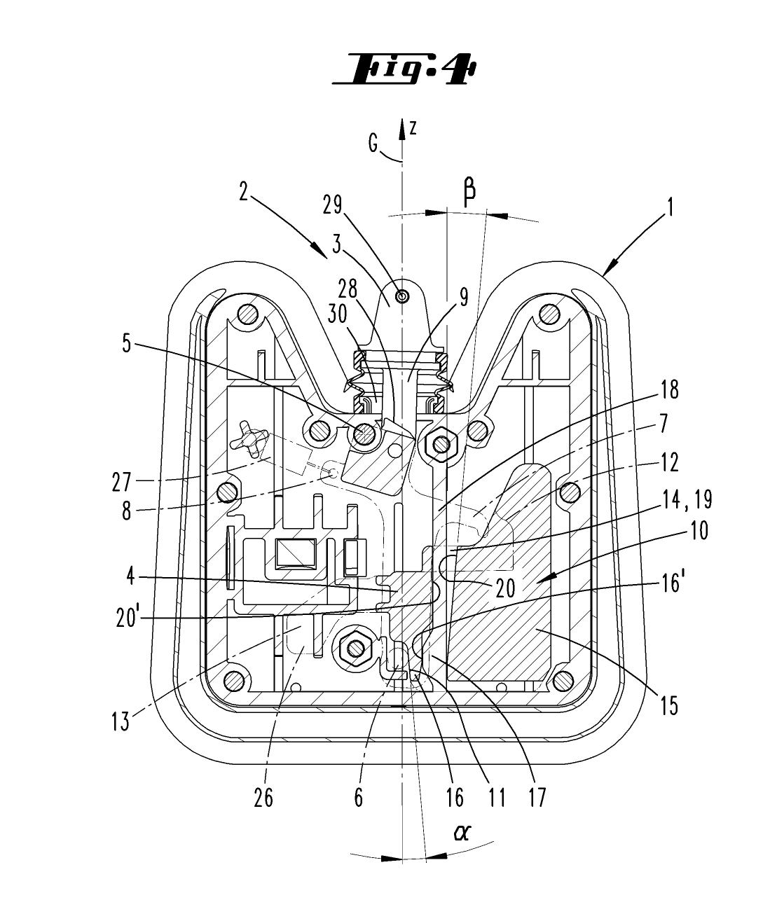

In the initial position (FIGS. 1, 4) of the opening slider 10, in which the opening slider 10 assumes a lower position and the locking cam 6 rests against the locking shoulder 11, the guide wall 20′ rests against the side wall of the guide rib 18. The locking shoulder 11 is inclined by an angle α as compared to a straight line G, which is placed through the latch head 3 in tensile direction, about the angle α. The angle α lies in the range between three and seven degrees and is preferably approximately five degrees. It lies in the self-locking range. The approximately wedge-shaped web 16 is located between control cam 6 and bearing protrusion 17. If a force is applied to the latch 3 in tensile direction Z, a torque acts upon the latch 2 as a result of the lateral offset of the pivot axis 5 as compared to the straight line G, so that the control cam 6 acts upon the web 16 against the bearing protrusion 17.

The opening slider 10 has a mass distribution, which is asymmetrical based on an axis, which is placed through the guide groove 19. It has a mass accumulation 15, which is arranged on the side of the opening slider 10 located opposite the web 16. A locking arm 13 extends on the side of the web 16. (FIG. 1)

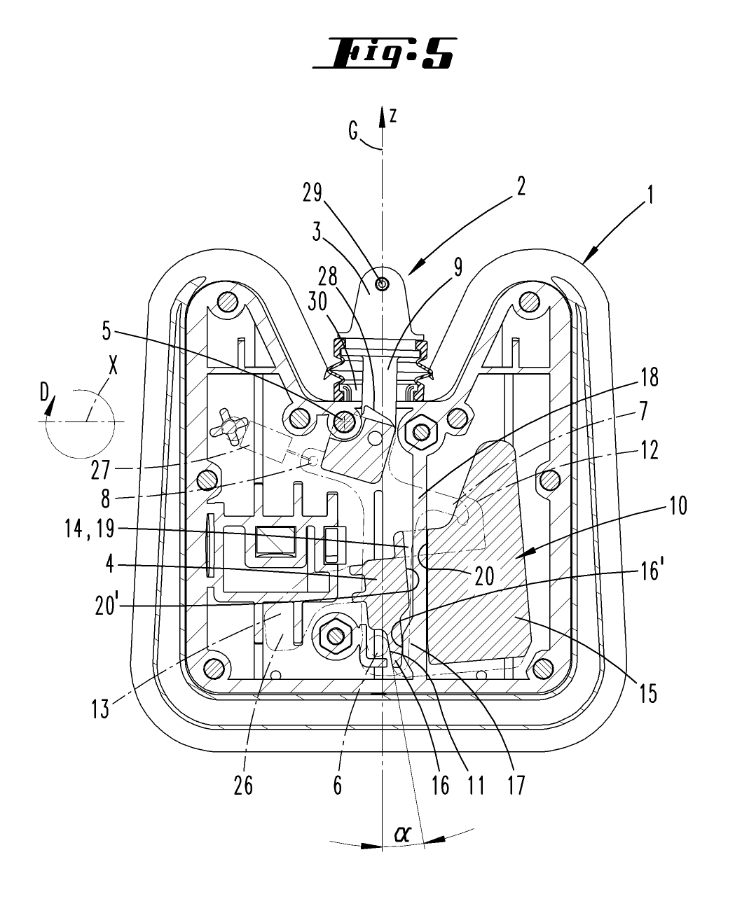

If, starting in a position in which the latch 2 is oriented upwards, and in particular in the direction of an opening direction of rotation D, the lock housing 1 is rotated, about an axis X, which runs at right angles to the tensile direction Z, the force of gravity and the mass accumulation 15 on the one side has the effect that the opening slider 10, which is clamped between locking cam 6 and bearing protrusion 17 in the area of the web 16 (FIG. 5), carries out a pivot movement about its contact point on the bearing protrusion 17. The wall 20′ of the guide groove 19 thereby detaches from the guide rib 18. The wall 20 of the guide groove 19, which is located opposite the wall 20′, runs at an angle β to the wall 20′, so that the guide groove 14 widens upwards. If the wall 20 rests against the guide rib 18, the opening slider 10 has pivoted about an angle β. Associated therewith, the web 16 and the locking shoulder 11 formed by the web has also pivoted about the same angle β, so that the angle of inclination of the locking shoulder 11 as compared to the straight line G has increased. According to the invention, the angle of inclination is increased in such a manner as a result of the tilting of the opening slider 10 that it lies outside of the self-locking range. It is then approximately 8-13 degrees. The opening slider 10 can preferably pivot about an angle β of between three and seven degrees, preferably by approx. five degrees.

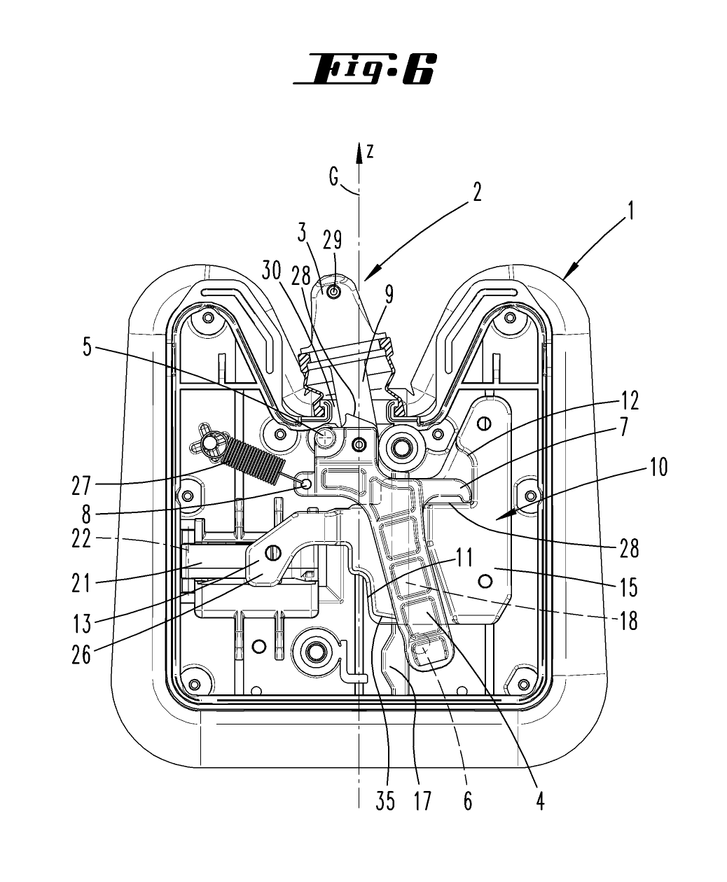

After the self-locking has been eliminated, the opening slider 10 can be displaced into its operating position (FIG. 6). It is thereby displaced along the guide rib 18 in the direction of the latch head 3, thus from bottom to top in the drawings. In the operating position, the locking shoulder 11 is no longer located in the pivot area of the locking cam 6, so that the control arm 4 and thus the latch 2 can pivot into a release position. The pivoting of the latch 2 into the release position is supported by the opening slider 10 in that a control shoulder 28 engages with a control cam 7 of the latch 2.

When the lock housing 1 is rotated back again, the opening slider 10 is displaced back into its initial position again as a result of the force of gravity, which acts upon it (FIG. 1). The latch 2 is displaced back into the locked position with the help of the return spring 27. The return spring 27, however, is unnecessary, because the opening slider 10, which is displaced downwards, acts upon the locking cam 6 by means of a control shoulder 35, so as to pivot the control arm 4. The control shoulder 35 is located on an outer edge of the opening slider 10. The control shoulder 35 is attached to the locking shoulder 11 by forming an angle. In the transition area to the locking shoulder 11, the control shoulder 35 forms a bevel. If the control slider 10 is displaced back from the displaced position illustrated in FIG. 6 into the initial position, a force is exerted on the locking cam 6, which exerts a torque on the control arm 4, so that the control arm 4 pivots back into its initial position, wherein the locking cam 6 glides along the control shoulder 35.

In the alternative, however, a control shoulder 27 can also act on the control cam 7 of the latch 2.

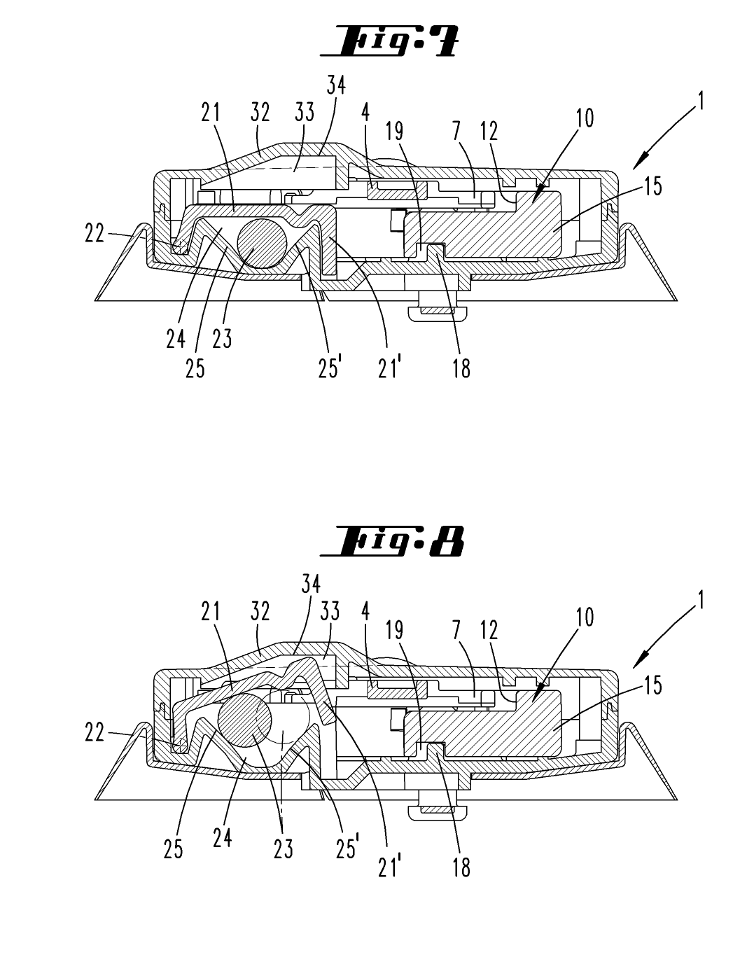

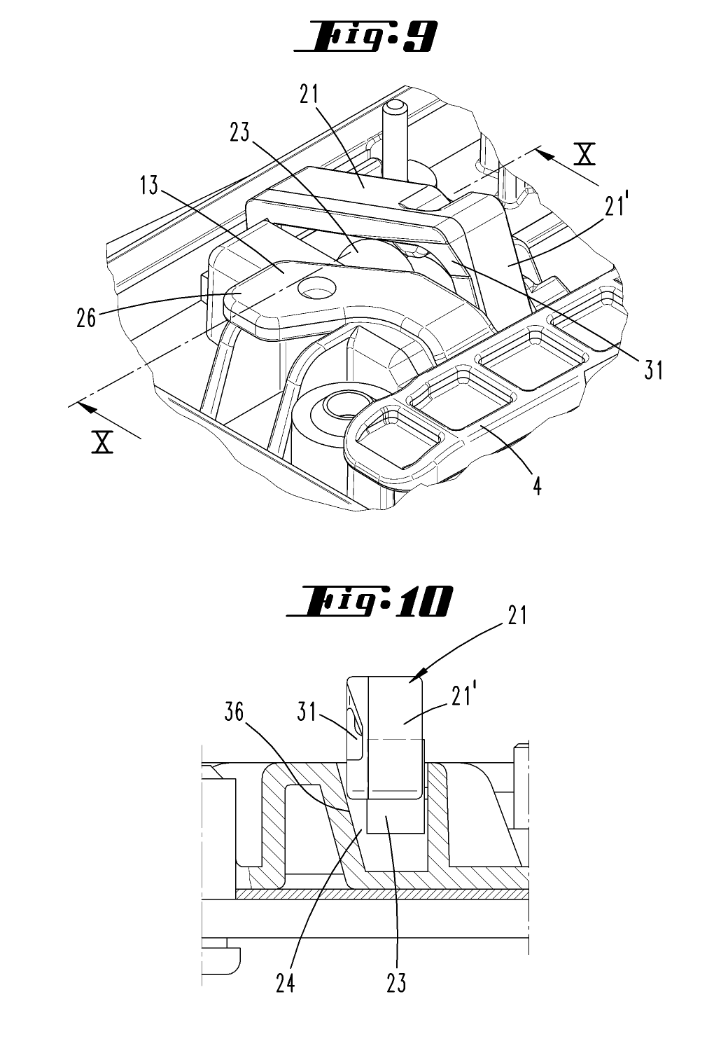

To avoid that the opening slider 10 is displaced out of the initial position when the lock housing 1 is not pivoted in the opening direction of rotation D about the opening axis of rotation X, provision is made for a misuse lock. For this purpose, the lock housing 1 has a pocket 24, which has a pocket bottom, which forms inclined bottom areas 25, 25′ on both of its end areas (FIGS. 7, 8). The pocket 24 extends at right angles to the direction of displacement of the opening slider 10, so that a rolling body 23, which is arranged in the pocket 24 and which forms a locking roller or a locking ball, can be displaced in the direction at right angles to the displacement direction of the opening slider 10, wherein depending on the pivot direction of the lock housing, the roll body 23 can run on one of the two inclined bottom areas 25, 25′ about a pivot direction, which is oriented at right angles to the opening axis of rotation. In the non-pivoted state, the rolling body 23 is located in the center between the two inclined bottom areas 25, 25′.

The pocket 24 is dosed by a locking lever 21. The locking lever 21 is a pivot lever 21. The pivot lever 21 is supported so as to be pivotable about a bearing axis 22. The bearing axis 22 extends parallel to the straight line G or to the tensile direction Z, respectively, and at right angles to the opening direction of rotation x. The rolling body 23 is located between the bottom areas 25, 25′ and the pivot lever 21 in the pocket 24. The rolling body 23 cannot roll out of the pocket 24 due to the fact that the pocket 24 is closed by the pivot lever 21.

In a non-illustrated exemplary embodiment, the pivot lever 21 has been omitted. The diameter of the rolling body 23 is then slightly enlarged and can come out of the pocket 24 so as to block the movement of the opening slider 10.

The pocket 24 furthermore has a bevel 36, along which the rolling body 23 can glide, when the trash container assumes its upright position. It thereby acts upon the pivot lever 21. As do the two inclined bottom areas 25, 25′, the bevel 36 also forms an inclined surface, which also forms a side wall of the pocket 31.

If the lock housing 1 is rotated about the opening axis of rotation X in the opening direction of rotation D (FIG. 7), the pivot lever 21 remains in the pocket 24, so that the arm 13 can run past the pivot lever 21 in response to a displacement of the opening slider 10 from the initial position into the operating position. If, in contrast, the lock housing 1 is rotated opposite the opening direction of rotation (FIG. 8), the pivot lever 21 comes out of the pocket 24 as a result of being acted upon by the force of gravity. The pivot lever 21 pivots about its bearing axis 22 into a locked position, in which it is located in the trajectory of the locking arm 13 of the opening slider 10, so that the opening slider 10 cannot leave its initial position.

If the lock housing is rotated about an axis, which is oriented at right angles to the opening direction of rotation X, the rolling body 23 rolls to the edge of the pocket 24, either on the inclined bottom area 25 or on the inclined bottom area 25′, wherein it pushes or can push the pivot lever 21 out of the pocket 24, so that the pivot lever 21 is located in the trajectory of the locking arm 13 and so that the opening slider 10 can also not leave its initial position.

The housing lid 32 has a recess 33, into which the pivot lever 21 can pivot, when it is pivoted into its locked position, wherein this can take place by acting upon the rolling body 23, when it rolls along the inclined area 25, 25′ or is displaced on the inclined shoulder 36. The bottom of the recess 33 forms a stop 34, against which the locking lever 21 can strike.

The locking lever 21 furthermore has a narrow journal 21′, which forms a pocket 31, into which the locking arm 13 can enter. The locking lever 21 is thus temporarily fixed in its locked position, until the opening slider 10 has moved back slightly. The pocket 31 forms a locking opening, into which the locking arm 13 can move.

The opening slider 10 can thus only leave its initial position and can be displaced into the operating position, when the pivot lever 21 is located in the pocket 24. In the operating position, a section of the locking arm 13 is located above the pocket 24 and thus prevents the pivot lever 21 from being pivoted.

The above explanations serve to explain the inventions, which are captured by the application as a whole, which further develop the prior art at least by means of the following feature combinations, in each case also independently, namely:

A trash can lock, which is characterized in that, in the initial position, the locking shoulder 11 is inclined about an angle of inclination a, which lies within the self-locking range, as compared to the displacement direction of the opening slider 10, and that the opening slider 10 can be rotated about an angle value β, which brings the angle of inclination a out of the self-locking range;

A trash can lock, which is characterized in that the locking shoulder 11 is formed by a web 16, which is supported on a bearing protrusion 17 of the housing 1;

A trash can lock, characterized by a guide rib 18, which is formed on the housing 1, for guiding the opening slider 10 and which engages with a guide groove 19 of the opening slider 10 with movement play;

A trash can lock, which is characterized in that the bearing protrusion 17 sits on the guide rib 18;

A trash can lock, which is characterized in that the rolling body 23 is located between a bottom area 25, 25′ of the pocket 24 and the pivot lever 21;

A trash can lock, which is characterized in that the bottom area of the pocket 24 forms two inclined shoulders 25, 25′, along which the rolling body 23 can roll in a direction at right angles to the pivot axis 22 of the pivot lever 21 and/or has a bevel 36, along which the rolling body 23 can glide;

A trash can lock, which is characterized in that the pivot axis 22 of the pivot lever 21 runs parallel to the displacement direction of the opening slider 10;

A trash can lock, which is characterized in that the rolling body 23 forms a roller or a ball;

A trash can lock, which is characterized in that the pivot lever 21 forms a pocket 31, into which a locking arm 13 of the opening slider 10 can enter in response to the displacement of the opening slider 10, so as to fix the pivot position of the pivot lever 21;

A trash can lock, which is characterized in that the pocket 24 is formed by the lock housing 1;

A trash can lock, which is characterized in that the pivot lever 21 interacts with an arm 26 of the opening slider 10.

All of the disclosed features (alone, but also in combination with one another) are essential for the invention. The disclosure content of the corresponding/enclosed priority documents (copy of the earlier application) is hereby also included in its entirety into the disclosure of the application, also for the purpose of adding features of these documents into claims of the instant application. The features of the subclaims characterize independent inventive further developments of the prior art, in particular for filing divisional applications on the basis of these claims.

1. A trash can lock comprising a latch, which is supported in a lock housing so as to be pivotable about a pivot axis and which has a latch head, to which a counter locking part can apply a tensile force in a tensile direction, and an opening slider, which can be displaced in the lock housing from an initial position into an operating position, wherein the latch has an arm comprising a locking cam, which, in the initial position, rests against a locking shoulder of the opening slider to hold the latch in the locked position, and which pivots into a release position in response to a displacement of the opening slider into the operating position, wherein the pivot axis of the latch is arranged so as to be laterally offset to a straight line, which is placed through the latch head in a tensile direction, in such a manner that the tensile force acts upon the locking cam against the locking shoulder, characterized in that, in the initial position, the locking shoulder is inclined about an angle of inclination, which lies within the self-locking range, as compared to the displacement direction of the opening slider, and that the opening slider can be rotated about an angle value, which brings the angle of inclination out of the self-locking range.

2. The trash can lock according to claim 1, characterized in that the locking shoulder is formed by a web, which is supported on a bearing protrusion of the housing.

3. The trash can lock according to claim 1, characterized by a guide rib, which is formed on the housing, for guiding the opening slider and which engages with a guide groove of the opening slider with movement play.

4. The trash can lock according to claim 1, characterized in that the bearing protrusion sits on the guide rib.

5. A trash can lock comprising a latch, which is supported in a lock housing so as to be pivotable about a pivot axis and comprising an opening slider, which is arranged in the lock housing and which is displaced from an initial position into an operating position in response to a rotation of the lock about an opening pivot axis in an opening direction of rotation, and thereby brings the latch from a locked position into a release position, wherein provision is made for misuse locking elements in the form of a pivot lever, which rests in a pocket, and in the form of a rolling body, which lock a displacement of the opening slider into the operating position, when the block is rotated in a direction of rotation, which is different from the opening direction of rotation, or about an axis of rotation, which is different from the opening axis of rotation, characterized in that the rolling body is located between a bottom area of the pocket and the pivot lever.

6. The trash can lock according to claim 5, characterized in that the bottom area of the pocket forms two inclined shoulders, along which the rolling body can roll in a direction at right angles to the pivot axis of the pivot lever and/or has a bevel, along which the rolling body can glide.

7. The trash can lock according to claim 5, characterized in that the pivot axis of the pivot lever runs parallel to the displacement direction of the opening slider.

8. The trash can lock according to claim 5, characterized in that the rolling body forms a roller or a ball.

9. The trash can lock according to claim 5, characterized in that the pivot lever forms a pocket, into which a locking arm of the opening slider can enter in response to the displacement of the opening slider, so as to fix the pivot position of the pivot lever.

10. The trash can lock according to claim 5, characterized in that the pocket is formed by the lock housing.

11. The trash can lock according to claim 5, is characterized in that the pivot lever interacts with an arm of the opening slider.

12. (canceled)
